(19) United States
(12) Patent Application Publication
(10) Pub. No.: US 2006/0268403 A1
(43) Pub. Date: Nov. 30, 2006

(54) Extrusions and corner brackets for a screen frame of a rear projection display

(76) Inventors: Michael Alain Cadio, Carmel, IN (US); Michael Stephen, Noblesville, IN (US)

Correspondence Address: THOMSON LICENSING INC., PATENT OPERATIONS, PO BOX 5312, PRINCETON, NJ, 08543-5312, US

(21) Appl. No.: 10/567,720

(22) PCT Filed: Aug. 10, 2004
(86) PCT No.: PCT/US04/25794

§ 371 Date: Feb. 8, 2006

Related U.S. Application Data
(60) Provisional application No. 60/498,262, filed on Aug. 26, 2003.

(51) Int. Cl. G03B 21/56

(52) U.S. Cl. 359/450

(57) ABSTRACT

A screen frame for mounting the screen on a rear projection display is disclosed. The screen frame is made using extrusions and corner brackets. The extrusions and corner brackets are assembled to form a thin frame for holding the screen on the display cabinet. The screen frame has a border of about 11.5 mm around the screen. The screen frame is mounted on the front of the display cabinet such that the screen protrudes in front of the cabinet.

### CROSS-REFERENCE TO RELATED APPLICATIONS

This application claims the benefit of U.S. Provisional Patent Application Ser. No. 60/498,262, entitled “Extrusions and Corner Brackets For A Screen Frame Of A Rear Projection Display” and filed Aug. 26, 2003, which is incorporated by reference herein in its entirety.

### FIELD OF THE INVENTION

The present invention is directed toward displays and in particular, toward rear projection displays.

### BACKGROUND OF THE INVENTION

Most rear projection displays include a screen mounted inside a plastic cabinet. As a result, these screens typically have a thick border greater than about 20 mm thick. Such a thick border undesirably reduces the viewable image area for the screen.

Thus, a need exists for an improved screen mounting arrangement having an increased viewable image area for the screen.

### SUMMARY OF THE INVENTION

The present invention is directed to a screen frame for mounting the screen on a rear projection display. The screen frame is made using extrusions and corner brackets. The extrusions and corner brackets are assembled to form a thin frame for holding the screen on the display cabinet. The screen frame has a border of about 11.5 mm around the screen. The screen frame is mounted on the front of the display cabinet such that the screen protrudes in front of the cabinet.

### BRIEF DESCRIPTION OF THE DRAWINGS

The invention is hereinafter described in detail with reference to the accompanying drawings, in which:

FIG. 1 depicts a cross-sectional view of one embodiment of the screen and screen frame mounted to the front of a display cabinet;

FIGS. 2A-2B depict front and side views of the screen and screen frame shown in FIG. 1;

FIG. 3 depicts a side view of a corner bracket for holding the extrusions together; and

FIGS. 4A-4B depict enlarged side views of a portion of the corner brackets and screen shown in FIGS. 1 and 3.

### DETAILED DESCRIPTION

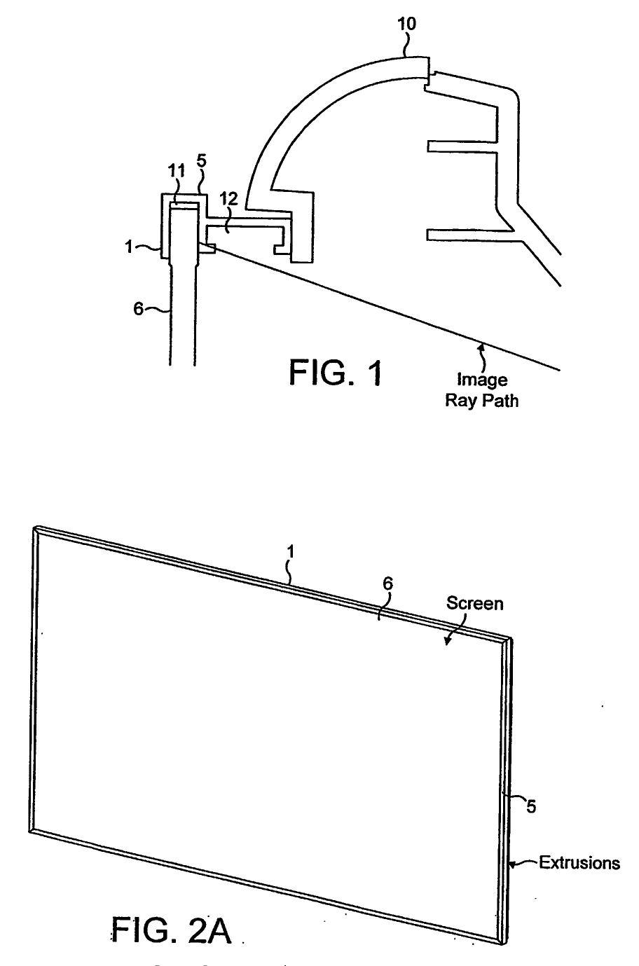

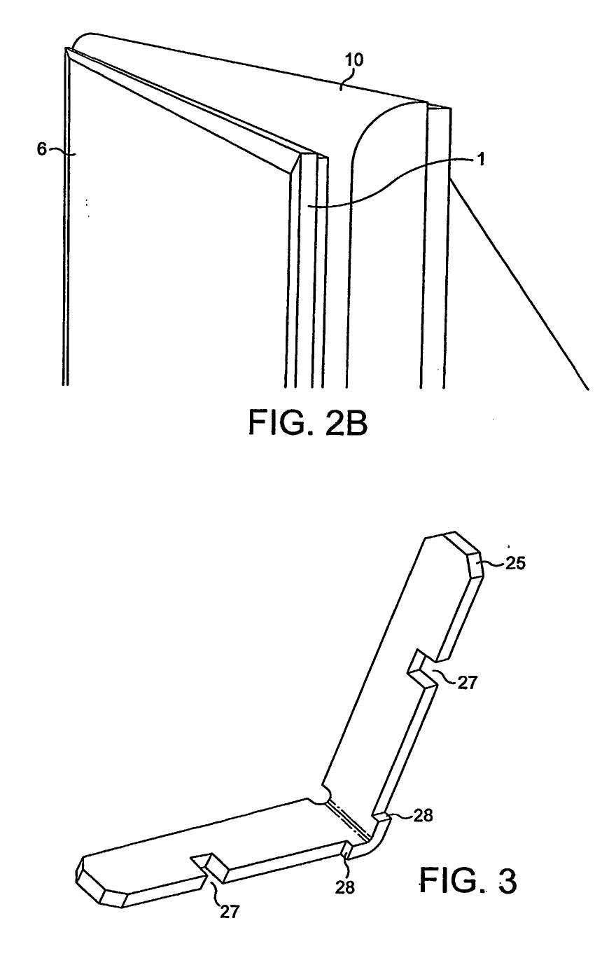

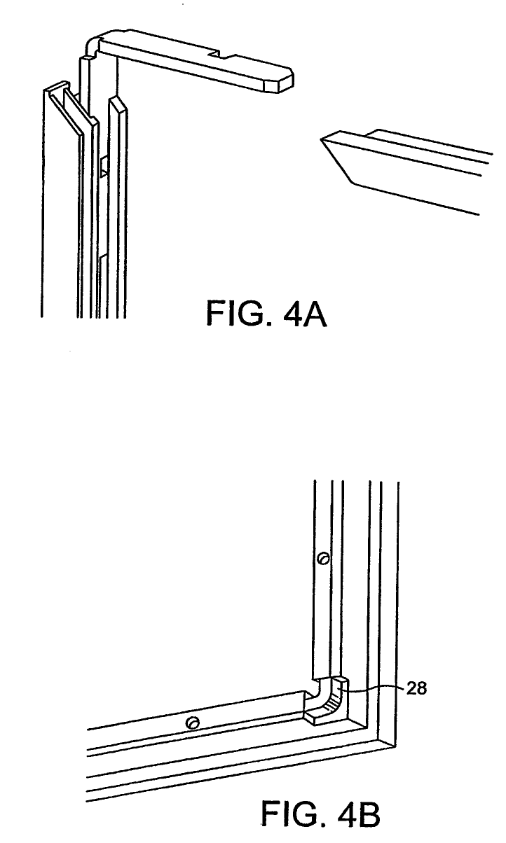

The present invention is directed to a screen frame for mounting the screen on a rear projection display. Referring to FIG. 1, the screen frame 1 is mounted on the front of the display cabinet 10 such that the screen 6 protrudes in front of the cabinet (FIG. 2B). The screen frame is made using extrusions 5 and corner brackets 25 (FIGS. 1 and 3). The extrusions 5 and corner brackets 25 are assembled as shown in FIGS. 4A-4B to form a thin frame for holding the screen 6 on the display cabinet 10 (FIG. 1). The screen frame 1 has a border of about 11.5 mm around the screen 6 (FIG. 2A).

The extrusions 5 may be formed of a metal, such as for example, aluminum (Al), or plastic and may be made using any suitable process such as for example sheet metal forming, roll forming, die casting and extrusion, among others. The corner brackets 25 may be form of a metal or plastic and may be made using any suitable process such as for example sheet metal forming, roll forming, die casting and extrusion, among others.

Each corner bracket 25 includes notches 27 for securing the bracket to the extrusions 5 and locating stops 28 for evenly forming the corners of the frame 5 (FIG. 3).

Referring to FIG. 1, each extrusion 5 includes a slot 11 for holding the screen 6 as well as a slot 12 for the corner bracket 25. To mount the screen frame 1 to the screen 6, a corner bracket 25 is positioned in a bracket slot 12 of one extrusion (FIG. 4A). The locating stop 28 positions the extrusion 5 such that corners of the frame 1 will be properly aligned. A second extrusion 5 is affixed to the corner bracket along a second bracket slot 12 therein to form one corner of the screen frame 1 (FIG. 4B). The corner bracket 25 is secured to the extrusion 5 with locking screws (not shown).

Two corner brackets 25 and extrusions 5 are assembled thus providing a frame 1 with three sides. Thereafter the screen 6 is slid into the screen slots 11 of the extrusions 5. The fourth side of the frame is then secured to the screen by sliding the fourth extrusion 5 and corner brackets 25 into position and securing them.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A screen frame for a projection display, comprising:
a plurality of corner brackets; and
a plurality of extrusions, wherein each extrusion has a first slot within which the corner brackets are positioned and a second slot within which a screen is positioned, and wherein the screen frame and screen protrude in front of a display cabinet of the projection display.

2. The screen frame of claim 1 wherein the extrusions are formed of a material selected from the group consisting of metal and plastic.

3. The screen frame of claim 1 wherein the corner brackets are formed of a material selected from the group consisting of metal and plastic.

4. The screen frame of claim 1 wherein each corner bracket includes at least one notch for securing the bracket to the extrusion.

5. The screen frame of claim 1 wherein each corner bracket includes at least one stop.

6. A projection display having a screen frame, comprising:
a plurality of corner brackets; and
a plurality of extrusions, wherein each extrusion has a first slot within which the corner brackets are positioned and a second slot within which a screen is positioned, and wherein the screen frame and screen protrude in front of a display cabinet of the projection display.

7. The projection display of claim 6 wherein the extrusions are formed of a material selected from the group consisting of metal and plastic.

8. The projection display of claim 6 wherein the corner brackets are formed of a material selected from the group consisting of metal and plastic.

9. The projection display of claim 6 wherein each corner bracket includes at least one notch for securing the bracket to the extrusion.

10. The projection display of claim 6 wherein each corner bracket includes at least one stop.
